(19) United States
(12) Patent Application Publication
(10) Pub. No.: US 2015/0033859 A1
(43) Pub. Date: Feb. 5, 2015

(54) PHYSICAL QUANTITY DETECTOR

(71) Applicant: MITUTOYO CORPORATION, Kanagawa (JP)

(72) Inventor: Shogo SHIRASAWA, Kanagawa (JP)

(21) Appl. No.: 14/448,108

(22) Filed: Jul. 31, 2014

(30) Foreign Application Priority Data
Aug. 1, 2013 (JP) 2013-160050

(51) Int. Cl. G01P 15/125

(52) U.S. Cl. CPC G01P 15/125
USPC 73/514.32

(57) ABSTRACT

A physical quantity detector includes a first displacement detector configured by a pair of capacitors, which are configured by first movable electrodes formed on a pendulum, and a pair of first fixed electrodes; a second displacement detector provided below the first displacement detector, and configured by a pair of capacitors, which are configured by second movable electrodes formed on the pendulum, and a pair of second fixed electrodes; a first detection circuit detecting a difference between capacitance values of each of the pair of capacitors of the first displacement detector; a second detection circuit detecting the difference between the capacitance values of each of the pair of capacitors of the second displacement detector; and an instrumentation amplifier calculating a difference between the differences in the capacitance values detected by the first detection circuit and the second detection circuit.

### CROSS-REFERENCE TO RELATED APPLICATIONS

The present application claims priority under 35 U.S.C. §119 of Japanese Application No. 2013-160050, filed on Aug. 1, 2013, the disclosure of which is expressly incorporated by reference herein in its entirety.

### BACKGROUND OF THE INVENTION

1. Field of the Invention

The present invention relates to a physical quantity detector detecting a physical quantity such as displacement, speed, and acceleration of a measured object. In particular, the present invention relates to a capacitance-type physical quantity detector detecting a physical quantity based on a difference in capacitance.

2. Description of Related Art

Conventionally, various physical quantity detectors have been proposed which detect a physical quantity such as displacement, speed, and acceleration of a measured object. For example, a capacitance-type accelerometer detecting a physical quantity based on a difference in capacitance has been used in measurements such as observation of earthquake ground motion, various vibration tests, and the like. A known example of such an accelerometer is a servo-type accelerometer (see, e.g., Japanese Patent Laid-open Publication No. 2004-205284). A “servo-type accelerometer” refers to an accelerometer measuring acceleration by detecting an amount of displacement due to an external force of a pendulum positioned within a main case and measuring amperage where an electric current proportionate to the amount of displacement flows to a coil driving the pendulum in order to keep the pendulum still. HHHHH

For example, a conventional accelerometer 200, as shown in FIG. 4, includes a driver 201, a pendulum 202, a displacement detector 203, a detection circuit 204, and a current amplification circuit 205. The driver 201 is configured to include a pair of permanent magnets 201a and two drive coils 201b. The driver 201 generates an electromagnetic force by sending electric current to the drive coils 201b and returns the pendulum 202 to a neutral position using the electromagnetic force.

The displacement detector 203 is configured to include a pair of capacitors C21 and C22 formed by movable electrodes 202a formed on the pendulum 202, and by a pair of fixed electrodes 203a provided with the movable electrodes 202a therebetween. The displacement detector 203 outputs to the detection circuit 204 a value for a capacitance measured by the pair of fixed electrodes 203a. The detection circuit 204 detects a difference between the capacitance values of each of the pair of capacitors C21 and C22 in the displacement detector 203, and thereby detects acceleration of the pendulum 202, which is output to the current amplification circuit 205. Based on the output from the detection circuit 204, and in order to impart an electromagnetic force for returning the pendulum 202 to the neutral position, the current amplification circuit 205 controls the amperage of the drive coils 201 b of the driver 201.

In the conventional accelerometer 200, when acceleration is added to the pendulum 202 and the pendulum 202 displaces from the neutral position, based on the difference between the capacitance values of each of the capacitors C21 and C22, control is performed such that electric current flows to the drive coils 201b of the driver 201 and the pendulum 202 is returned to the neutral position.

However, in the conventional accelerometer 200, an influence due to temperature may cause temperature drift, and therefore measurement accuracy may deteriorate.

### SUMMARY OF THE INVENTION

The present disclosure provides a physical quantity detector capable of eliminating an influence of temperature drift and of improving measurement accuracy.

In one aspect of the present disclosure, which was conceived to resolve the above-noted circumstance, a physical quantity detector includes a first displacement detector, a second displacement detector, a first detection circuit, a second detection circuit, and a calculator. The first displacement detector is configured by a pair of capacitors formed by first movable electrodes formed on two oscillation-direction surfaces of a pendulum rotatably supported at one end, and by a pair of first fixed electrodes positioned so as to have the pendulum therebetween and so as to be opposite the first movable electrodes. The second displacement detector is provided below the first displacement detector and is configured by a pair of capacitors formed by second movable electrodes formed on two oscillation-direction surfaces of the pendulum, and by a pair of second fixed electrodes positioned so as to have the pendulum therebetween and so as to be opposite the second movable electrodes. The first detection circuit detects a difference between capacitance values of each capacitor of the first displacement detector. The second detection circuit detects a difference between capacitance values of each capacitor of the second displacement detector. The calculator calculates a difference between the differences in the capacitance values detected by the first detection circuit and the second detection circuit.

In another aspect of the present disclosure, the physical quantity detector includes a magnetic field former forming a magnetic field; test coils; an error determiner; and an outputter. The test coils are positioned within the magnetic field formed by the magnetic field former and cause the pendulum to oscillate with the force generated by the flow of an electric current. The error determiner determines that there is an error in a case where, when the electric current flows to the test coils, at least one of the outputs from the first detection circuit and the second detection circuit is equal to or less than a predetermined threshold value. The outputter outputs an error result in a case where the error determiner has determined that there is an error.

According to the present disclosure, by subtracting a temperature drift component of a second displacement detector from a temperature drift component of a first displacement detector, an influence of temperature drift can be eliminated, and therefore measurement accuracy can be improved.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 schematically illustrates an overall configuration of a physical quantity detector according to the present disclosure;

FIG. 2 is a flowchart illustrating operations of the physical quantity detector according to the present disclosure;

FIG. 3 is a flowchart illustrating an operation confirmation process of the physical quantity detector according to the present disclosure; and

FIG. 4 is both a lateral view and a block diagram schematically illustrating an overall configuration of a physical quantity detector according to the prior art.

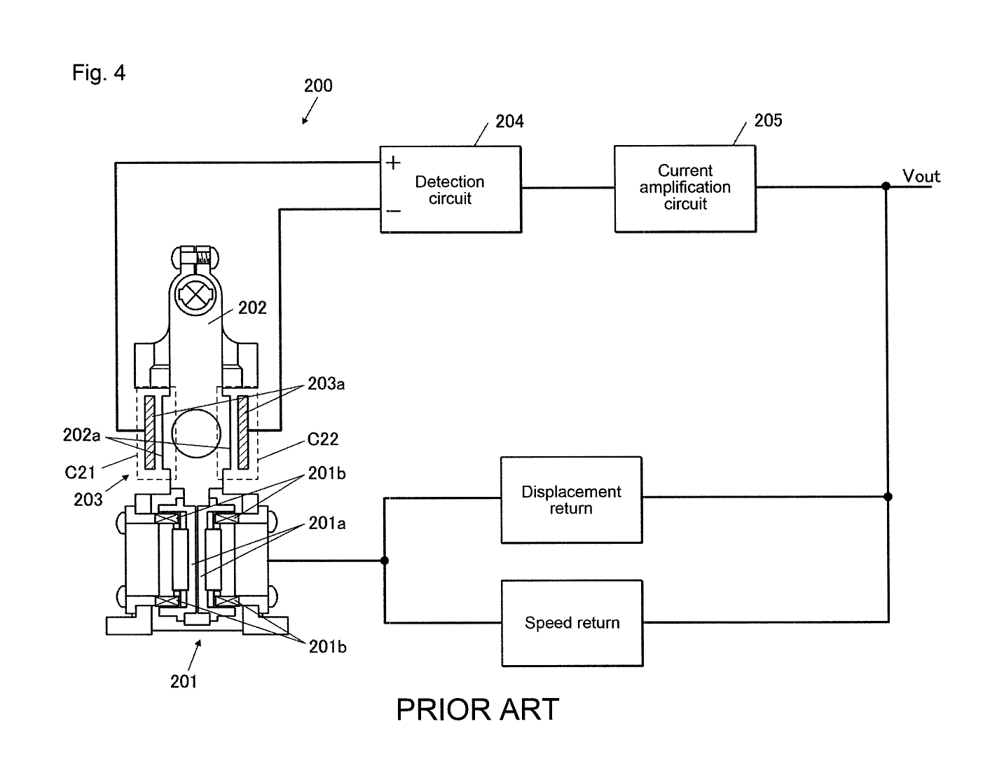

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

An embodiment of the present disclosure is described in detail below with reference to the drawings. Moreover, in the present embodiment, an accelerometer 100 is described as an exemplary physical quantity detector.

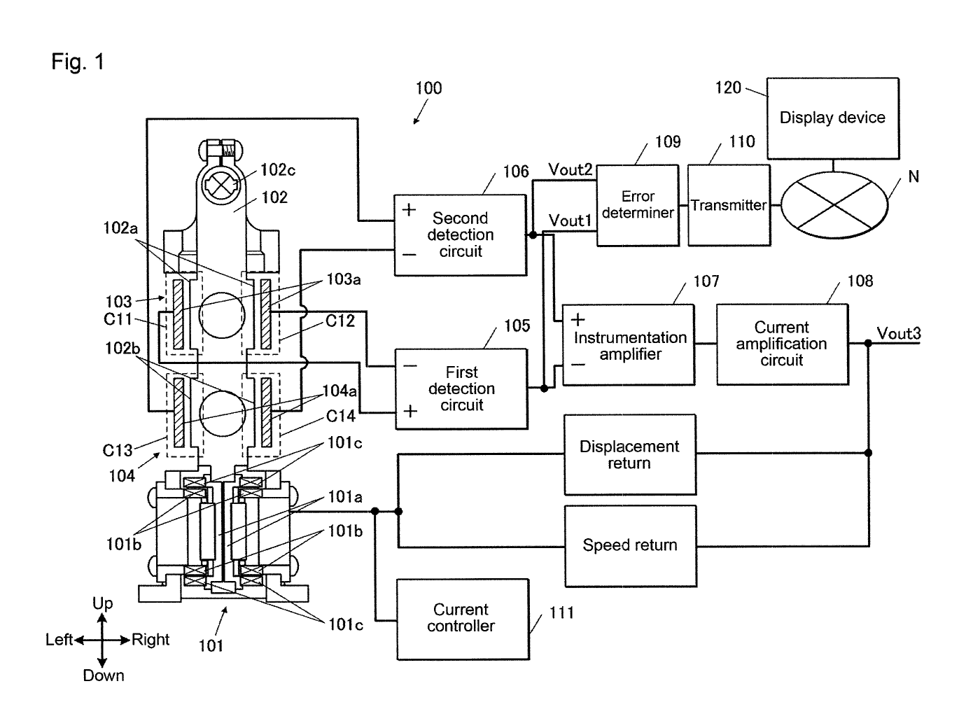

The accelerometer 100 according to the present embodiment includes, as shown in FIG. 1, a driver 101, a pendulum 102, a first displacement detector 103, a second displacement detector 104, a first detection circuit 105, a second detection circuit 106, an instrumentation amplifier 107, a current amplification circuit 108, an error determiner 109, a transmitter 110, and a current controller 111. The accelerometer 100 is connected to a display device 120 via a network N. Furthermore, the driver 101 and the pendulum 102 of FIG. 1 are described with reference to an up-down direction and a left-right direction shown in the drawing.

The driver 101 is integrally formed with the pendulum 102. The driver 101 is configured to include a pair of permanent magnets 101a aligned in the left-right direction and positioned on a lower end of the pendulum 102; two drive coils 101b coiling around an axis that lies along the left-right direction; and two test coils 101c coiling around the same axis as the drive coils 101b, on an outer surface side of the drive coils 101b. The drive coils 101b are provided within a magnetic field formed by the permanent magnets 101a, and therefore, due to an electric current amplified by the current amplification circuit 108 flowing to the drive coils 101b, an electromagnetic force is generated in a direction negating oscillation of the pendulum 102. The pendulum 102 then displaces to a neutral position due to the generated electromagnetic force. Also, because the test coils 101c are provided within the magnetic field formed by the permanent magnets 101a, the pendulum 102 is made to oscillate due to the electromagnetic force generated by the current controller 111 sending an electric current to the test coils 101c. Specifically, the permanent magnets 101a are magnetic field formers (also referred to as magnetic field generators) forming (or generating) the magnetic field.

The first displacement detector 103 is configured to include a pair of capacitors C11 and C12 configured by first movable electrodes 102a formed on two surfaces of the pendulum 102, rotatably supported at one end by an X-shaped spring 102c; and by a pair of first fixed electrodes 103a positioned so as to have the pendulum 102 therebetween and so as to be opposite the first movable electrodes 102a. The first displacement detector 103 outputs to the first detection circuit 105 a capacitance value for each of the pair of capacitors C11 and C12. The second displacement detector 104 has a configuration similar to that of the first displacement detector 103 and is provided below the first displacement detector 103. The second displacement detector 104 is configured to include a pair of capacitors C13 and C14 configured by second movable electrodes 102b formed on two surfaces of the pendulum 102, and by a pair of second fixed electrodes 104a configured by members identical to the pair of first fixed electrodes 103a. The second displacement detector 104 outputs to the second detection circuit 106 a capacitance value for each of the pair of capacitors C13 and C14.

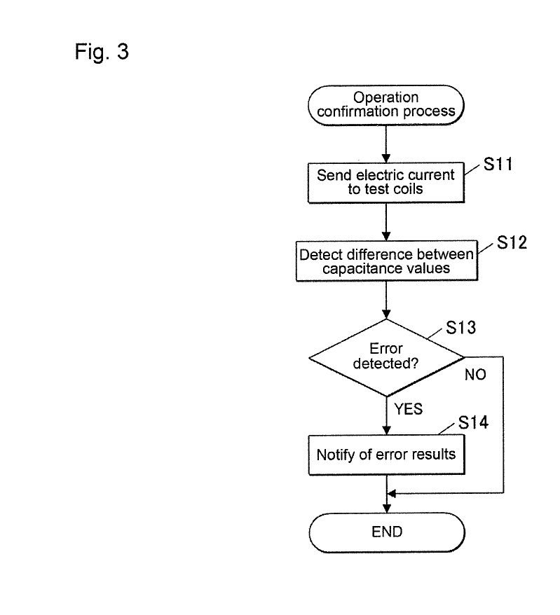

Based on the output from the pair of capacitors C11 and C12 of the first displacement detector 103, the first detection circuit 105 detects a difference between the capacitance values of each of the capacitors C11 and C12, and thereby detects acceleration of the pendulum 102, which is output to the instrumentation amplifier 107. The second detection circuit 106 is configured by members identical to those of the first detection circuit 105 and, based on the output from the pair of capacitors C13 and C14 of the second displacement detector 104, the second detection circuit 106 detects a difference between the capacitance values of each of the capacitors C13 and C14, and thereby detects acceleration of the pendulum 102, which is output to the instrumentation amplifier 107. Moreover, in a case where an operation confirmation process is performed (see FIG. 3), the first detection circuit 105 and the second detection circuit 106 output the detected difference in capacitance to the error determiner 109 rather than to the instrumentation amplifier 107.

Based on the output from the first detection circuit 105 and the second detection circuit 106, the instrumentation amplifier (calculator) 107 calculates a difference between the differences in the capacitance values detected by the first detection circuit 105 and the second detection circuit 106, then outputs the calculated difference to the current amplification circuit 108. Based on the output from the instrumentation amplifier 107, and in order to impart an electromagnetic force for returning the pendulum 102 to the neutral position, the current amplification circuit 108 controls an amperage output to the drive coils 101b of the driver 101.

In the accelerometer 100 according to the present embodiment, when acceleration is added to the pendulum 102 and the pendulum 102 displaces from the neutral position (which is the measurement point “zero” position), based on a value in which the differences between capacitance values have been subtracted from each other by the instrumentation amplifier 107, control is performed such that electric current flows to the drive coils 101b of the driver 101 and an electromagnetic force is generated in a direction negating the oscillation of the pendulum 102, and the pendulum 102 is returned to the neutral position.

The error determiner 109 checks the output from each of the detection circuits 105 and 106, and determines whether an error has been detected. Specifically, the error determiner 109 determines whether an output Vout1 from the first detection circuit 105 is equal to or less than a predetermined threshold value. The error determiner 109 also determines whether an output Vout2 from the second detection circuit 106 is equal to or less than a predetermined threshold value. Herein, the predetermined threshold value is a value expected to be measured when the displacement detectors and the detection circuits are functioning normally. Specifically, in a case where the output Vout1 is below the predetermined threshold value, this indicates that at least one of the first displacement detector 103 and the first detection circuit 105 is not functioning effectively. Similarly, in a case where the output Vout2 is below the predetermined threshold value, this indicates that at least one of the second displacement detector 104 and the second detection circuit 106 is not functioning effectively. In a case where a determination of an error is made, i.e., in a case where at least one of the output Vout1 from the detection circuit 105 and the output Vout2 from the detection circuit 106 is equal to or less than the predetermined threshold value, the error determiner 109 outputs an error result to the transmitter 110.

Based on the output from the error determiner 109, the transmitter (outputter) 110 outputs the error result to the display device 120. The display device 120 is configured by an LCD, for example. Based on the output from the transmitter 110, the display device 120 displays a screen to give a notification of the error result, for example. In a case where the operation confirmation process is performed (see FIG. 3), the current controller 111 controls the amperage output to the test coils 101c.

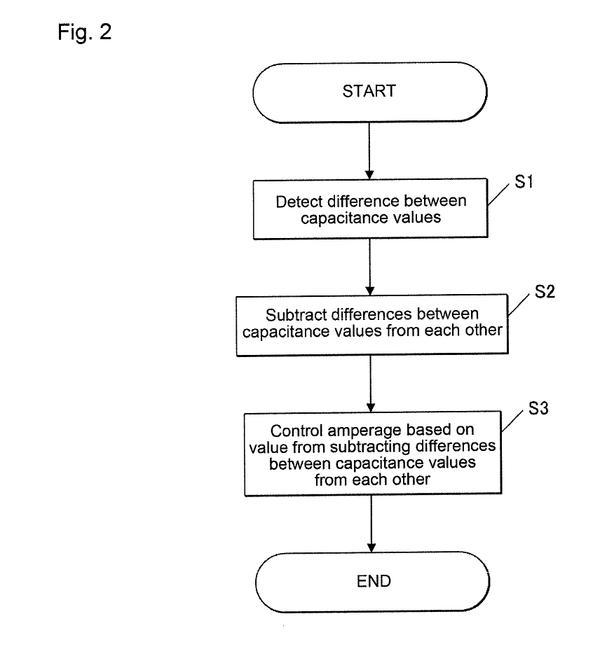

Next, operations of the accelerometer 100 according to the present embodiment are described with reference to the flowchart of FIG. 2. First, based on the capacitance values detected by the first displacement detector 103 and the second displacement detector 104, the first detection circuit 105 and the second detection circuit 106 detect differences between the capacitance values (step S1). Specifically, the first detection circuit 105 detects the difference between the capacitance values measured by the pair of first fixed electrodes 103a (pair of capacitors C11 and C12) of the first displacement detector 103. Also, the second detection circuit 106 detects the difference between the capacitance values measured by the pair of second fixed electrodes 104a (pair of capacitors C13 and C14) of the second displacement detector 104. Herein, the difference between the capacitance values of the capacitor C11 and the capacitor C12 is defined as ΔC_{A}, which can then be calculated with Formula (1). Similarly, the difference between the capacitance values of the capacitor C13 and the capacitor C14 is defined as ΔC_{B}, which can then be calculated with Formula (2).

$$\begin{matrix}Δ {C}_{A} = ɛ \frac{S ( - 2 Δ {d}_{A} )}{( {d}_{0} + Δ {d}_{A} ) ( {d}_{0} - Δ {d}_{A} )} & ( 1 ) \\ Δ {C}_{B} = ɛ \frac{S ( - 2 Δ {d}_{B} )}{( {d}_{0} + Δ {d}_{B} ) ( {d}_{0} - Δ {d}_{B} )} & ( 2 )\end{matrix}$$

Moreover, in Formulae 1 and 2, ε indicates permittivity in a vacuum (8.854×10⁻¹² [F/m]); d₀ indicates a gap length in an initial state; Δd_{A} indicates an amount of change in the gap length of the capacitor C11 (distance on the capacitor C11 between the first fixed electrode 103a and the pendulum 102); and Δd_{B} indicates the amount of change in the gap length of the capacitor C13 (distance on the capacitor C13 between the second fixed electrode 104a and the pendulum 102).

Next, the instrumentation amplifier 107 subtracts the differences between the capacitance values from each other (step S2). Specifically (see Formula (3)), the instrumentation amplifier 107 subtracts the difference between the capacitance values detected by the first detection circuit 105 (see Formula (1)) and the difference between the capacitance values detected by the second detection circuit 106 (see Formula (2)).

$$Δ {C}_{A} - Δ {C}_{B} = ɛ \frac{S ( - 2 Δ {d}_{A} )}{( {d}_{0} + Δ {d}_{A} ) ( {d}_{0} - Δ {d}_{A} )} - ɛ \frac{S ( - 2 Δ {d}_{B} )}{( {d}_{0} + Δ {d}_{B} ) ( {d}_{0} - Δ {d}_{B} )} = ɛ S \frac{2 ( Δ {d}_{B} - Δ {d}_{A} ) ( {d}_{0}^{2} + Δ {d}_{A} Δ {d}_{B} )}{( {d}_{0}^{2} - Δ {d}_{A}^{2} ) ( {d}_{0}^{2} - Δ {d}_{B}^{2} )} \qquad ( 3 )$$

Next, the current amplification circuit 108 controls the amperage (step S3). Specifically, based on the value obtained by subtracting the differences between the capacitance values from each other in step S2, and in order to impart an electromagnetic force for returning the pendulum 102 to the neutral position, the current amplification circuit 108 controls the amperage output to the drive coils 101b of the driver 101.

Moreover, the present embodiment includes two sets of a displacement detector and a detection circuit. Therefore, even in a case where a defective status occurs in one of the sets of displacement detector and detection circuit, the acceleration can be measured. Therefore, the present embodiment includes a function (operation confirmation function) determining whether the sets of displacement detectors and detection circuits are functioning normally. Hereafter, the operation confirmation process of the accelerometer 100 according to the present embodiment is described with reference to the flowchart of FIG. 3. First, the current controller 111 causes electric current to flow to the test coils 101c (step S11). Specifically, the current controller 111 causes a predetermined electric current to flow to the test coils 101c. An electromagnetic force is generated when the electric current flows to the test coils 101c, and the electromagnetic force causes the pendulum 102 to oscillate. When this occurs, the electric current is configured to not flow to the drive coils 101b of the driver 101.

Next, the first detection circuit 105 and the second detection circuit 106 detect the differences between the capacitance values (step S12). Specifically, the first detection circuit 105 detects the difference between the capacitance values measured by the pair of first fixed electrodes 103a of the first displacement detector 103 (see Formula (1)). Also, the second detection circuit 106 detects the difference between the capacitance values measured by the pair of second fixed electrodes 104a of the second displacement detector 104 (see Formula (2)). The differences between the capacitance values measured by each of the first detection circuit 105 and the second detection circuit 106 are output to the error determiner 109.

Next, the error determiner 109 checks the output from each of the detection circuits 105 and 106 and determines whether an error has been detected (step S13). Specifically, the error determiner 109 determines whether the output Vout1 from the first detection circuit 105 is equal to or less than a predetermined threshold value. The error determiner 109 also determines whether the output Vout2 from the second detection circuit 106 is equal to or less than a predetermined threshold value. In a case where the error determiner 109 detects an error (step S13: YES), i.e., in a case where at least one of the output Vout1 from the first detection circuit 105 and the output Vout2 from the second detection circuit 106 is equal to or less than the predetermined threshold value, the process advances to the next step, step S14. Meanwhile, in a case where the error determiner 109 does not detect an error (step S13: NO), i.e., in a case where the outputs Vout1 and Vout2 from each of the detection circuits 105 and 106 are equal to or greater than the predetermined threshold value, the operation confirmation process ends.

Next, the transmitter 110 gives a notification of the error result (step S14). Specifically, based on the output from the error determiner 109, the transmitter 110 generates a screen to give a notification of the error result, i.e., a screen showing that there is an error in the output (output Vout1 and output Vout2) for which the error was detected in step S13, and displays the screen on the display device 120. In addition, operations of the displacement detector and detection circuit involved in the output for which the error was detected are stopped and the operation confirmation process ends.

As noted above, the accelerometer 100 according to the present embodiment includes the first displacement detector 103, the second displacement detector 104, the first detection circuit 105, the second detection circuit 106, and the instrumentation amplifier (calculator) 107. The first displacement detector 103 is configured by the pair of capacitors C11 and C12, which are configured by the first movable electrodes 102a formed on two oscillation-direction surfaces of the pendulum 102, which is rotatably supported at one end, and the pair of first fixed electrodes 103a positioned opposite each other with the pendulum 102 therebetween. The second displacement detector 104 is provided below the first displacement detector 103, and is configured by the pair of capacitors C13 and C14, which are configured by the second movable electrodes 102b formed on two surfaces of the pendulum 102, and the pair of second fixed electrodes 104a positioned opposite each other with the pendulum 102 therebetween. The first detection circuit 105 detects the difference between the capacitance values of the pair of capacitors C11 and C12 of the first displacement detector 103. The second detection circuit 106 detects the difference between the capacitance values of the pair of capacitors C13 and C14 of the second displacement detector 104. The instrumentation amplifier (calculator) 107 calculates the difference between the differences in the capacitance values detected by the first detection circuit 105 and the second detection circuit 106. Thus, according to the accelerometer 100 according to the present embodiment, by subtracting a temperature drift component of the second displacement detector 104 from the temperature drift component of the first displacement detector 103, an influence of temperature drift can be eliminated, and therefore measurement accuracy can be improved. Also, by subtracting the differences of the capacitance values detected by the first detection circuit 105 and the second detection circuit 106, external vibration during measurement and 1/f noise can be reduced, and therefore measurement accuracy can be improved.

The accelerometer 100 according to the present embodiment also includes permanent magnets 101a forming a magnetic field; test coils 101c positioned within the magnetic field formed by the permanent magnets 101a and causing the pendulum 102 to oscillate with the force generated by the flow of an electric current; the error determiner 109 determining that there is an error in a case where, when the electric current flows to the test coils 101c, at least one of the outputs from the first detection circuit 105 and the second detection circuit 106 is equal to or less than a predetermined threshold value; and a transmitter (outputter) 110 outputting the error result in a case where the error determiner 109 has determined that there is an error. Thus, according to the accelerometer 100 according to the present embodiment, in a case where a defective status occurs in one of the sets of displacement detector and detection circuit, an operator can be notified of the error, therefore prompting rapid repair work. Also, the output in which the error occurred can be identified, and therefore displacement detector and detection circuit operations related to the output in which the error occurred can be stopped and acceleration can be measured using only the other output.

In the above, a concrete description was given based on an embodiment according to the present invention. However, the present invention is not limited to the above-described embodiment and can be modified without deviating from the scope of the invention.

For example, in the above-described embodiment, two sets of displacement detectors (the first displacement detector 103 and the second displacement detector 104) are provided; however, the present invention is not limited to this. For example, instead of providing two sets of displacement detectors, the displacement detector 203 of the prior art can be split in two. In such a case, by adding one new detection circuit, two sets of displacement detector and detection circuit can be provided, similarly to the above-described embodiment.

Further, the above-described embodiment includes the test coils 101c, the error determiner 109, and the display device 120, for example, in order to perform the operation confirmation process; however, the present invention is not limited to this. In other words, the operation confirmation process is not an essential feature of the present invention, and therefore the present invention can also be configured so as to not include the test coils 101c, the error determiner 109, the transmitter 110, the current controller 111, and the display device 120, for example.

In addition, in the above-described embodiment, a description was given in which the display device 120 exemplified an output destination of the transmitter 110; however, the present invention is not limited to this. For example, the present invention may also be configured to include a speaker capable of audio output or the like and, instead of performing a display on the display device 120, may be configured to perform audio output from the speaker indicating that an error has been detected. Alternatively, audio may be output from the speaker simultaneously with performing a display on the display device 120. In addition, when the accelerometer 100 is installed in an environment which the operator can visually observe, a display may also be provided to the accelerometer 100.

In the above-described embodiment, the accelerometer 100 is described as an exemplary physical quantity detector; however, the present invention is not limited to this. For example, the present invention can also be applied to a device such as a displacement meter or a speedometer detecting a physical quantity, instead of to the accelerometer 100.

Additionally, appropriate modifications not deviating from the scope of the present invention can also be made to detailed structures and operations of each component configuring the accelerometer 100.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A physical quantity detector comprising:
a first displacement detector comprising a first pair of capacitors, the first pair of capacitors comprising:
first movable electrodes formed on two oscillation-direction surfaces of a pendulum rotatably supported at one end; and
a pair of first fixed electrodes positioned so as to have the pendulum therebetween and so as to be opposite the first movable electrodes;
a second displacement detector positioned below the first displacement detector and comprising a second pair of capacitors, the second pair of capacitors comprising:
second movable electrodes formed on two oscillation-direction surfaces of the pendulum;
a pair of second fixed electrodes positioned so as to have the pendulum therebetween and so as to be opposite the second movable electrodes;
a first detection circuit configured to detect a difference between capacitance values of each capacitor of the first displacement detector;
a second detection circuit configured to detect a difference between capacitance values of each capacitor of the second displacement detector; and
a calculator configured to calculate a difference between the differences in the capacitance values detected by the first detection circuit and the second detection circuit.

2. The physical quantity detector according to claim 1, comprising:
a magnetic field generator configured to generate a magnetic field;
a plurality of test coils positioned within the magnetic field generated by the magnetic field generator and causing the pendulum to oscillate with a force generated by the flow of an electric current;
an error determiner configured to determine that there is an error in a case where, when the electric current flows to the plurality test coils, at least one of the outputs from the first detection circuit and the second detection circuit is equal to or less than a predetermined threshold value; and
an outputter configured to output an error result in a case where the error determiner has determined that there is an error.
